(19) United States
(12) Patent Application Publication
(10) Pub. No.: US 2015/0039610 A1
(43) Pub. Date: Feb. 5, 2015

(54) METHOD AND SYSTEM FOR A DATA ACCESS BASED ON DOMAIN MODELS

(71) Applicants: Thomas Hubauer, Munchen (DE); Steffen Lamparter, Feldkirchen (DE); Mikhail Roshchin, Feldkirchen (DE); Giuseppe Fabio Ceschini, Nurnberg (DE); Stuart Watson, Newark (GB)

(72) Inventors: Thomas Hubauer, Munchen (DE); Steffen Lamparter, Feldkirchen (DE); Mikhail Roshchin, Feldkirchen (DE); Giuseppe Fabio Ceschini, Nurnberg (DE); Stuart Watson, Newark (GB)

(21) Appl. No.: 13/955,053

(22) Filed: Jul. 31, 2013

(51) Int. Cl. G06F 17/30

(52) U.S. Cl. CPC G06F 17/30483
USPC 707/736; 707/769; 707/774

(57) ABSTRACT

A system, a method and a computer product are disclosed. The method includes using at least one domain ontology including a plurality of domain models connected through mappings to a plurality of data sources, the data sources storing data to be accessed by the query; receiving a query by a query formulation unit; evaluating at least one of a language for defining at least one of the domain models involved in the query, a language of mappings involved in the query and a language of the query and selecting a query answering mode in accordance with results of the evaluation and retrieving an answer meeting at least one query condition from the data sources.

### TECHNICAL FIELD

The present disclosure relates to a system and method for accessing data based on domain models. More specifically, the present disclosure relates to a method for a domain-model-based data access configured to automatically select an appropriate query answering mode.

### BACKGROUND

A domain model is used as a conceptual layer in order to present a unified conceptual specification of the domain of interest. A particular domain model, also referred to as ontology, is frequently defined as being adapted for additionally supporting reasoning between the conceptual specifications besides modeling the domain. However, the boundaries between domain models and ontologies are not clearly defined with respect to a rapid development of research in this field of endeavor.

Hereinafter, a data access based on domain models is also referred to as an ontology-based data access, without detracting from the general concept of domain models.

The field of ontology-based data access addresses the challenge of making large amounts of data accessible to users in a structured way, based on ontological descriptions of the underlying semantics.

The essence of ontology-based data access is using an ontology that confronts the user with a conceptual model of a particular domain. A user formulates information needs, that is, requests in terms of the ontology and then receives the answers in the same understandable form. To this end, a set of mappings is maintained which describes the relationship between terms in the ontology and data sources.

As an illustrative example, consider the following scenario: In a large data base, huge amounts of information about turbines and other related appliances are stored. This data includes operational information such as sensor measurements, event data issued by control units, etc. Further said data includes structural information such as the partonomy of turbines and power plants, geographic information, e.g. plant locations, and environmental information such as temperature, humidity, power grid demand data etc.

Consider a situation where a domain expert in the field of turbines wants to query the data base for all turbines from a specific fleet, which are located close to a certain specified location of one of the power plants and exhibiting a particular temperature-dependent pattern in acquired sensor signals over the last week.

Typically, domain experts have a deep understanding about the working of their equipment the way of diagnosing the equipment. However, storage and accessibility of data is usually exclusively administered by an IT (information technology) expert making it complicated to gather all data required for diagnosing a particular system or a collection of systems.

Data access based on domain models bridges this gap by allowing the domain expert to pose such questions in a domain language represented by a domain model, e.g. an ontology. Based on models defined by the domain expert and IT expert in joint work and mappings provided by the IT expert, this question is then translated into one or several queries over involved data sources. The results are again returned in the respective user vocabulary terms.

In this process, not only explicitly available information is returned. With the aid of reasoning the result may also include answers to the query which have not been given explicitly but result implicitly from known facts, given the domain model. A model-based data access further addresses an evaluation and processing of a query over data sources as well as re-integrating results into an answer.

As to the process of query processing, two major approaches are currently known. According to a first approach, also known as materialization, the domain model is used to complete the data set of a query by making all implicit conclusions explicit, which means storing explicit conclusions in the data source. One major drawback of materialization is that this approach can be time-consuming and as soon as the underlying data changes, the materialization must typically be recomputed.

According to a second approach, also known as perfect rewriting, the user query is transformed into a rewritten query over data sources without having to materialize conclusions. Said perfect rewriting of one query into rewritten query is only dependent on the mappings and the domain model. The process of perfect rewriting is not dependent on particular data sets stored in the data sources. In order to apply perfect rewriting, however, languages used for representing the domain model, the mapping, and the user query have to be >>weak<< enough, which excludes an application of this approach for certain environments. Consequently, only model languages guaranteeing so-called first-order rewritability permit a perfect rewriting approach.

More recently, a third approach was suggested, which picks up the idea of rewriting the user query, but weakens the restrictions on the modeling language. This is achieved by making the rewriting dependent on the data, resulting in a so-called combined rewriting of the query. On the downside, these rewritten queries obviously cannot be reused any longer when data changes.

Currently applied query processing exhibits inherent restrictions with respect to applicability in certain environments and performance under given conditions. This leads to a need for choosing an appropriate query processing with respect to knowledge about storage and accessibility of data sources, which is, at present, rather in the discretion of an IT expert.

Accordingly, there is a need in the art for a model-based data access by a query, which does not require expert knowledge with respect to storage and accessibility of data sources.

### SUMMARY

Systems and methods in accordance with various embodiments of the present disclosure provide for a data access based on domain models using a query.

In one embodiment, a method for a data access based on domain models and using a query is disclosed, including the steps of:
a) using at least one domain model including a plurality of domain models connected through mappings to a plurality of data sources, the data sources storing data to be accessed by said query;
b) receiving a query by a query formulation unit;
c) evaluating at least one of a language for defining at least one of said domain models involved in the query, a language of mappings involved in the query and a language of the query and selecting a query answering mode in accordance with results of said evaluation; and;
d) retrieving an answer meeting at least one query condition from said data sources.

According to an embodiment, the domain model or domain models are represented as an ontology.

According to an embodiment, pre-specified constraints including memory requirements and/or performance of a query answering mode are evaluated in conjunction with the evaluating steps c) mentioned above.

According to an embodiment, pre-specified constraints including processing time and pre-processing expenditure of a query answering mode to be selected are evaluated in conjunction with the evaluating steps c) mentioned above.

According to an embodiment, a repeated usage of a similar or identical query answering mode is evaluated in conjunction with the evaluating steps c) mentioned above.

According to an embodiment, the query answering mode includes at least partially or a combination of:
a perfect rewriting of at least parts of the query;
a materialisation of at least parts of the query; and/or
a combined rewriting of at least parts of the query.

According to an embodiment, the evaluation includes:
determining at least one sub-query;
evaluating said sub-query; and;
selecting a query answering mode for said sub-query in accordance with results of said evaluation.

According to an embodiment, said evaluation of said sub-query includes a determination whether said sub-query is materialized.

If, according to an embodiment, an already materialized sub-query is present, said materialized sub-query is directly accessed for the purpose of retrieving an answer for said sub-query.

If, according to an embodiment, a sub-query is not materialized, a counter for repeated usage or frequent usage of a similar or a substantially identical sub-query is evaluated for deriving a decision of materializing said sub-query.

According to an embodiment, a system for an ontology-based data access using a query is disclosed, the system comprising:

a) at least one domain model including a plurality of domain models connected through mappings to a plurality of data sources, the data sources storing data to be accessed by said query;
b) a query formulation unit for entering said query to the system;
c) a query answering mode selection unit for evaluating at least one of a language for defining at least one of said domain models involved in the query, a language of mappings involved in the query and a language of the query, the query answering mode selection unit configured to select a query answering mode in accordance with results of said evaluation;
d) a query execution unit for retrieving an answer meeting at least one query condition from said data sources.

According to an embodiment, a computer program product is disclosed.

The foregoing is a summary and thus contains, by necessity, simplifications, generalizations, and omissions of detail. It would be understood that aspects for different embodiments may be combined. Those skilled in the art will appreciate that the summary is illustrative only and is not intended to be in any way limiting. Other aspects, features, and advantages, as defined solely by the claims, will become apparent in the non-limiting detailed description set forth below.

### BRIEF DESCRIPTION OF THE DRAWING

In the accompany drawings:

FIG. 1 shows a block diagram of a system for an ontology-based data access according to the state of the art;

FIG. 2 shows a block diagram of a system for an ontology-based data access according to an embodiment of the disclosure; and;

FIG. 3 shows a flow chart of a method for an ontology-based data access using sub-queries according to an embodiment of the disclosure.

### DETAILED DESCRIPTION

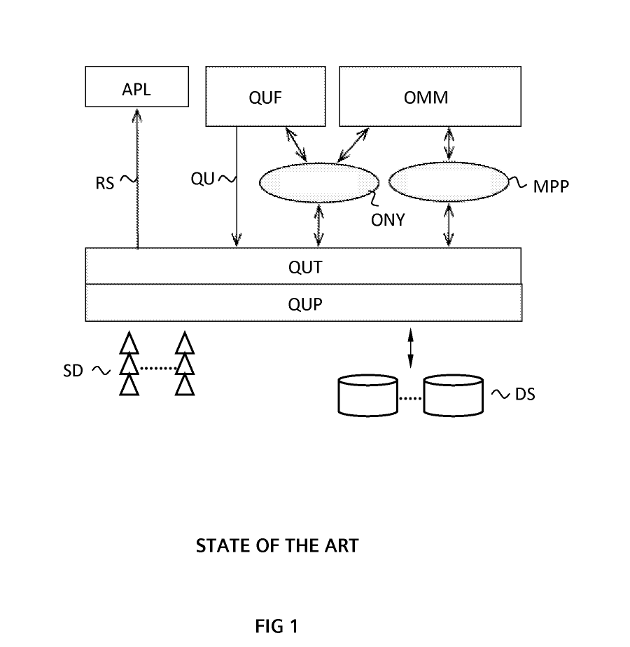

In FIG. 1 a block diagram of a system for an ontology-based data access—hereinafter OBDA—according to the state of the art is depicted.

The OBDA system addresses a data access by presenting a general ontology-based query interface over data sources. Data sources generally include external, independent, heterogeneous, computational structures such as databases, documents, semi-structured data or streaming data. In FIG. 1, two heterogeneous examples of data sources are exemplarily shown, namely streaming data SD and a non-volatile data source DS.

Core elements of the systems include at least one ontology ONY, describing the application domain, and a set of mappings MPP, relating the ontological terms with the schemata of the underlying data sources. In other words, mappings MPP are used to semantically link data at the data sources to the ontology ONY.

An end-user, i.e. domain expert, formulates a query QU aided by a query formulation editor QUF using ontological terms. Ideally, domain experts are not required to understand the structure of the underlying data sources.

The query QU is executed over the data sources with the participation of a query transformation unit QUT and a query execution unit QUP.

Finally, a result RS delivers an answer or rather a set of answers to the query in an intelligible form similar to the query. The result RS is delivered to an application APL used by the domain expert.

A further component in known OBDA systems is an ontology and mapping management unit OMM which includes functionalities allowing for an IT-expert to administer, amend and/or maintain the set of mappings MP or the set of ontologies ONY.

At present a considerable amount of research addresses a variety of approaches how a query can be evaluated over the data sources, how a query can be processed in view of the mappings and the data sources and how the results can be reintegrated into one answer.

As to the process of query processing, two major approaches are currently known.

A first approach, also known as materialization, follows the idea of using the domain model in order to complete a data set of the query by making all implicit conclusions explicit, which means storing explicit conclusions in the data source. One major drawback of materialization is that this approach can be time-consuming and memory-consuming. Further on, as soon as the underlying data changes, the materialization must be updated.

According to a second approach, also known as perfect rewriting, the user query is transformed into a rewritten query over data sources without having to materialize conclusions. Said perfect rewriting of one query into rewritten query is only dependent on the mappings and the domain model. The process of perfect rewriting is not depending on particular data sets stored in the data sources. In order to apply perfect rewriting, however, languages used for representing the domain model, the mapping, and the user query have to be >>weak<< enough, which excludes an application of this approach for certain environments. Consequently, only model languages guaranteeing a so-called first-order rewriteability permit a perfect rewriting approach.

More recently, a third approach was suggested, which picks up the idea of rewriting the user query, but weakens the restrictions on the modeling language. This is achieved by making the rewriting dependent on the data, resulting in a so-called combined rewriting of the query. On the downside, these rewritten queries obviously cannot be reused any longer when data changes.

In current systems for OBDA, IT-experts developing the system as well as domain experts have to decide in advance which approach they want to follow, as this choice determines the applied algorithms as well as the languages supported formulating domain knowledge, mappings, and user queries.

There are situations, where the expressivity of model, mapping and query language is not fully known in advance or not completely under the control of the designer of an OBDA system. This lack of control may be due to external partners, domain requirements, etc.

Such situations complicate a selection of an appropriate system in advance and frequently lead to suboptimal selections, e.g. for a materialisation-based approach in a context where a perfect rewriting would be feasible instead.

Aggravating this situation, even if parameters like expressivity of model, mapping and query language are known in advance, these parameters are rather worst-case assumptions which need not be relevant in the context of a single, given query posed by the domain expert. For instance, a certain query under consideration is typically not dependent on all data items and/or all parts of the domain model. More typically, only a small part of the domain model must be considered for answering a query—and the expressivity of this >>module<< of the ontology may be much lower than that of the full domain model.

Similarly, a particular query may only use part of the query formulation language, resulting in lower complexity. Such situation occurs for the exemplary case when generally a domain model language >>OWL 2 Full<< is used for the domain model and a query formulation language >>SPARQL<< is used for query formulation. In this situation a specific query may nevertheless only depend on a part of the domain model, which is expressible using a domain model language >>DL Lite<<. Then, query answering can be done using perfect rewriting techniques although this approach is generally not feasible for OWL 2 domain models.

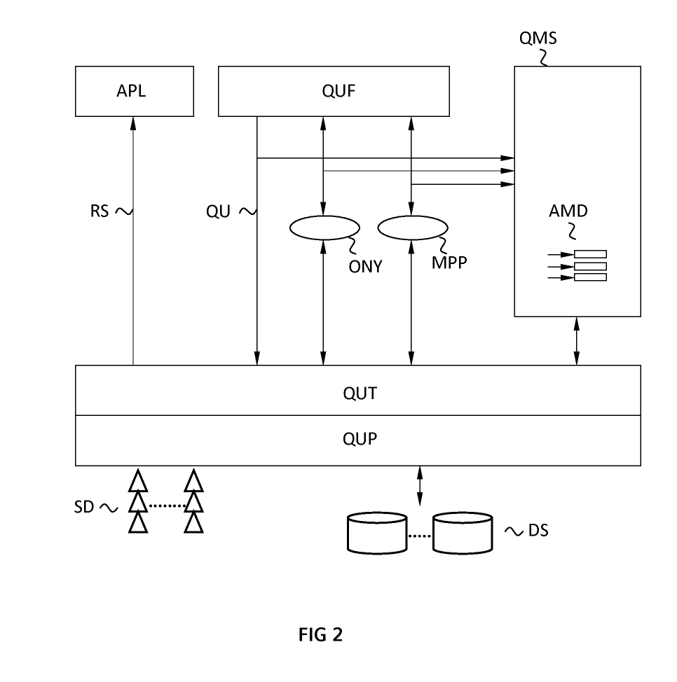

Referring now to FIG. 2, a block diagram of a system for an ontology-based data access according to an embodiment of the disclosure is shown.

The system shown in FIG. 2 is simplified for purposes of illustrating embodiments of the disclosure. However, those of ordinary skill in the art will realize that the system may include a plurality of each illustrated entity as a function of the size of the system. Further, where considered appropriate, reference signs have been repeated among the figures to indicate corresponding elements so that repeated introductions can be waived.

Hereinafter, a data access based on domain models according to various embodiments of the invention is also referred to as an ontology-based data access, without detracting from the general concept of domain models. The skilled artisan will recognize that the embodiments ontology-based embodiments are readily applicable for the general concept of data access based on domain models.

FIG. 2 shows a system for an ontology-based data access using a query AU, comprising at least one domain ontology ONY including a—not shown—plurality of domain models connected through mappings MPP to a plurality of data sources DS, SD, the data sources DS, SD storing data to be accessed by said query QU. The system further includes a query formulation unit QUF for entering said query QU to the system.

A query answering mode selection unit QMS is included in the system for evaluating at least one of a language for defining at least one of said domain models involved in the query QU, a language of mappings involved in the query QU and a language of the query QU, the query answering mode selection unit QMS configured to select a query answering mode AMD in accordance with results of said evaluation.

The system further includes a query execution unit QUP for retrieving an answer meeting at least one query condition from said data sources DS, SD.

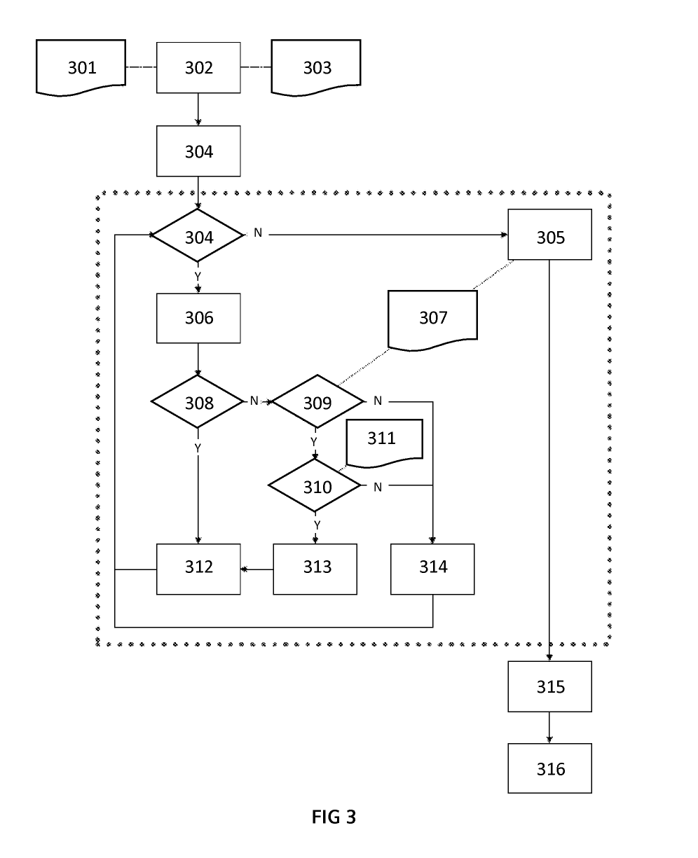

Although the system of FIG. 3 my further comprise a—not shown—ontology and mapping management unit known from the description of FIG. 2. This unit is omitted in FIG. 3 for the sake of clarity. Further reference signs in FIG. 3 identical to FIG. 2 are to be understood as reference to identical elements so that repeated introductions can be waived.

According to an embodiment, a system is proposed addressing the currently known problems in ontology-based data access by automatically selecting an appropriate query answering mode AMD based by a query answering mode selection unit QMS. The appropriate query answering mode AMD is selected by an evaluation of the languages used for defining—or, similar: formulating—at least one domain model, the languages used for defining at least one mapping, and the languages used for the query. A sufficient information basis for this evaluation is available as outlined before.

According to an embodiment, further aspects additionally addressing the technical environment may advantageously influence the evaluation in order to attain a most suitable query answering mode for answering a given query.

Among these, pre-specified constraints including memory requirements and/or performance of a query answering mode to be selected are evaluated. If memory is limited but time is not a vital issue, this trade-off may lead to the selection of rewriting-based approaches even if materialisation would be more efficient and/or time-efficient.

On the other hand, if the domain expert prefers instant answers but accepts significant pre-processing overhead, the query answering mode selection unit QMS may chose a materialisation-based approach even if perfect or combined rewritings are theoretically possible. Such pre-processing overhead mainly accrues on system initialisation and on updates data of the data sources. However, other pre-specified constraints including processing time of a query answering mode may also be subject of a preference of the domain expert. In general, preferences of a domain expert are administered by a user preferences repository of any common data format, such as a user preferences registry.

An embodiment is directed to an evaluation of a repeated usage of a similar query answering mode. If usage history of a query statistics shows that certain queries are used over and over again, the system may chose to materialise the query result once to save time later in the sense of amortised complexity. Such frequent usage may not only affect the query as a whole but also parts of a query or sub-queries, which are part of complex queries.

According to an embodiment, an evaluation of a repeated usage of a similar query answering mode is made on a sub-query basis, taking into account statistical data on the hardness of certain queries as well as heuristic estimates. This embodiment is further described with reference to FIG. 3 hereinafter.

This embodiment is, however, going beyond the approach of extending a rewriting-approach with sub-query materialisation. For instance, assume that the overall combination of model, mapping and query language has sufficient complexity to only allow for a materialisation-based approach. Nevertheless, there may be certain sub-queries which use only a restricted part of the domain model and only a subset of the mappings. These subsets, however, may have a much lower expressivity and thus be amenable to more efficient evaluation techniques such as a perfect rewriting approach.

According to the embodiment, such sub-queries are identified automatically and processed based on feasibility, user preferences and environmental constraints as outlined before.

The catalogue of decision criteria is, however, not restricted to the pre-specified constraints or decision criteria listed above. This embodiment of the disclosure rather focuses on a general approach of selecting a particular query answering method based on runtime considerations instead of assumptions like the language required for formulating the complete ontology.

FIG. 3 illustrates a flow chart of this embodiment. In a first step 302 a query answering is initiated by receiving a query 301. The query 301 may be entered into a—not shown—query formulation unit by a human domain expert, whereby the query formulation unit assists the expert in formulating the query.

In a subsequent step 302 the query is decomposed into a series of sub-queries and particular sub-queries of the series of sub-queries are identified.

At least one of the identified sub-queries is then transferred to an iterative process symbolized by a dotted lined box in FIG. 3 for further processing the at least one sub-query.

In a first decision step 304 a decision is made of whether the presently processed sub-query is the last of a series of sub-queries or not. If there are more sub-queries present in a series of sub-queries, which is represented by a branch Y (>>Yes<<) pointing vertically downward from decision step 304, a subsequent step 306 is carried out. If there no more sub-queries, represented by a branch N (>>No<<) of decision step 304, a subsequent step 305 is carried out.

If the outcome of decision step 304 results in that the current sub-query is the last sub-query, the processing of sub-queries is finalized. Accordingly, an update of query statistics according to step 305 is carried out, followed by an evaluation of a query plan in step 315 and returning query results in step 316. The update of query statistics according to step 305 is carried out in a query statistics 307.

If the outcome of decision step 304 results in that there are more sub-queries present in a series of sub-queries, a next sub-query to be processed is picked in step 306.

In a subsequent decision step 308 a decision is made of whether the presently processed sub-query is materialized or not. If the presently processed sub-query is materialized, which is represented by a branch Y (>>Yes<<) pointing vertically downward from decision step 308, a subsequent step 312 is carried out. If the presently processed sub-query is not materialized, represented by a branch N (>>No<<) of decision step 308, a subsequent decision step 309 is carried out.

If the outcome of decision step 308 results in that the current sub-query is already materialized, the query plan is updated to directly access the materialized result in step 312. After step 312 is finished, the processing is branched back to the beginning, i.e. to decision step 304. By using an already materialized sub-query the processing of this sub-query is considerably accelerated.

If the outcome of decision step 308 results in that the current sub-query is not materialized, a subsequent decision of whether the not materialized sub-query is frequent or not is carried out according to decision step 309. The decision step 309 determines a frequency of the current sub-query by accessing the query statistics 307.

If the presently processed sub-query is frequent, which is represented by a branch Y (>>Yes<<) pointing vertically downward from decision step 309, a subsequent decision step 310 is carried out. If the presently processed sub-query is not frequent, represented by a branch N (>>No<<) of decision step 309, a subsequent step 314 is carried out.

In step 314 which is reached when the presently processed sub-query is not frequent, the query plan is updated by the plan for the present sub-query. Due to the lacking frequency of the presently processed sub-query, materialization of this sub-query is not required. After step 314 is finished, the processing is branched back to the beginning, i.e. to decision step 304.

In decision step 310 which is reached by a decision 309 in that the presently processed sub-query is frequent, a decision is made of whether the presently processed sub-query is requested to be materialized or not. The decision step 310 determines a request for materialization of the current sub-query by accessing user preferences 311.

If the presently processed sub-query is requested to be materialized, which is represented by a branch Y (>>Yes<<) pointing vertically downward from decision step 310, a subsequent step 313 is carried out by which the materialization of the presently processed sub-query is carried out. Consequently, the query plan is updated to directly access the materialized result in step 312. After step 312 is finished, the processing is branched back to the beginning, i.e. to decision step 304.

If the presently processed sub-query is not requested to be materialized, which is represented by a branch N (>>No<<) of decision step 310, step 314 is carried out.

In step 314 which is reached when a materialization of the presently processed sub-query is not requested, the query plan is updated by the plan for the present sub-query. After step 314 is finished, the processing is branched back to the beginning, i.e. to decision step 304.

According to an embodiment, the processing of sub-queries described above is carried out in a parallel manner, which means that the steps 304-316 are instantiated for particular sub-queries which are processed concurrently.

Embodiments of the disclosure can be implemented in computing hardware (computing apparatus) and/or software, including but not limited to any computer or microcomputer that can store, retrieve, process and/or output data and/or communicate with other computers.

The processes can also be distributed via, for example, down-loading over a network such as the Internet. A program/software implementing the embodiments may be recorded on computer-readable media comprising computer-readable recording media. The program/software implementing the embodiments may also be transmitted over a transmission communication media such as a carrier wave.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed are meant to be illustrative only and not limiting to the scope of the invention, which is to be given the full breadth of the appended claims and any and all equivalents thereof. It should be noted that the term “comprising” does not exclude other elements or steps and the use of articles “a” or “an” does not exclude a plurality.

What is claimed is:

1. A method for an data access based on domain models using a query, including:
a) using at least one domain model including a plurality of domain models connected through mappings to a plurality of data sources, the data sources storing data to be accessed by the query;
b) receiving a query by a query formulation unit;
c) evaluating at least one of a language for defining at least one of the domain models involved in the query, a language of mappings involved in the query and a language of the query and selecting a query answering mode in accordance with results of the evaluation; and;
d) retrieving an answer meeting at least one query condition from the data sources.

2. The method according to claim 1,
wherein at least one of the domain models is represented by at least one ontology.

3. The method according to claim 1,
wherein pre-specified constraints including memory requirements and/or performance of a query answering mode to be selected are evaluated.

4. The method according to claim 1,
wherein pre-specified constraints including processing time and pre-processing expenditure of a query answering mode to be selected are evaluated.

5. The method according to claim 1,
wherein a repeated usage of a similar query answering mode is evaluated.

6. The method according to claim 1, wherein the query answering mode includes at least partially or a combination of:
a perfect rewriting of at least parts of the query;
a materialisation of at least parts of the query; and/or
a combined rewriting of at least parts of the query.

7. The method according to claim 1, wherein the evaluation includes:
determining at least one sub-query;
evaluating the sub-query; and
selecting a query answering mode for the sub-query in accordance with results of the evaluation.

8. The method according to claim 7,
wherein the evaluation of the sub-query includes a determination whether the sub-query is materialized.

9. The method according to claim 8,
wherein in case that the sub-query is materialized, the materialized sub-query is directly accessed for the purpose of retrieving an answer for the sub-query.

10. The method according to claim 8,
wherein in case that the sub-query is not materialized, a counter for repeated usage of a similar sub-query is evaluated for deriving a decision of materializing the sub-query.

11. A system for an ontology-based data access using a query, the system comprising:
a) at least one domain ontology including a plurality of domain models connected through mappings to a plurality of data sources, the data sources storing data to be accessed by the query;
b) a query formulation unit for entering the query to the system;
c) a query answering mode selection unit for evaluating at least one of a language for defining at least one of the domain models involved in the query, a language of mappings involved in the query and a language of the query, the query answering mode selection unit configured to select a query answering mode in accordance with results of the evaluation; and;
d) a query execution unit for retrieving an answer meeting at least one query condition from the data sources.

12. A computer program product comprising program code stored on a non-transitory computer-readable medium and which, when executed on a computer, is configured to:
a) use at least one domain ontology including a plurality of domain models connected through mappings to a plurality of data sources, the data sources storing data to be accessed by the query;
b) receive a query by a query formulation unit;
c) evaluate at least one of a language for defining at least one of the domain models involved in the query, a language of mappings involved in the query and a language of the query, and select a query answering mode in accordance with results of the evaluation; and;
d) retrieve an answer meeting at least one query condition from the data sources.
